(19) United States
(12) Patent Application Publication
(10) Pub. No.: US 2009/0246115 A1
(43) Pub. Date: Oct. 1, 2009

(54) Process for reaction of limestone with sulfate solution

(76) Inventors: Daniel W. Kappers, Reno, NV (US); Terence E. Albert, Reno, NV (US); Dennis M. Anderson, Carson City, NV (US)

Correspondence Address: Dennis M. Anderson, 3990 Timberline Dr., Carson City, NV, 89703, US

(21) Appl. No.: 12/383,515

(22) Filed: Mar. 25, 2009

Related U.S. Application Data
(63) Continuation-in-part of application No. 11/342,110, filed on Jan. 27, 2006, now abandoned.

(51) Int. Cl. C01B 31/24

(52) U.S. Cl. 423/419.1

(57) ABSTRACT

The present invention is a process to react limestone with sulfate and/or sulfuric acid solutions and/or other solutions containing sulfates, in order to neutralize the solutions and precipitate the sulfates, in such a way that the limestone is used with an efficiency that makes the use of limestone economic. In the present invention, the limestone is reacted with the solution continuously, in a high intensity reactor, which is designed to provide efficient high-energy input and continuous renewal of the limestone surface.

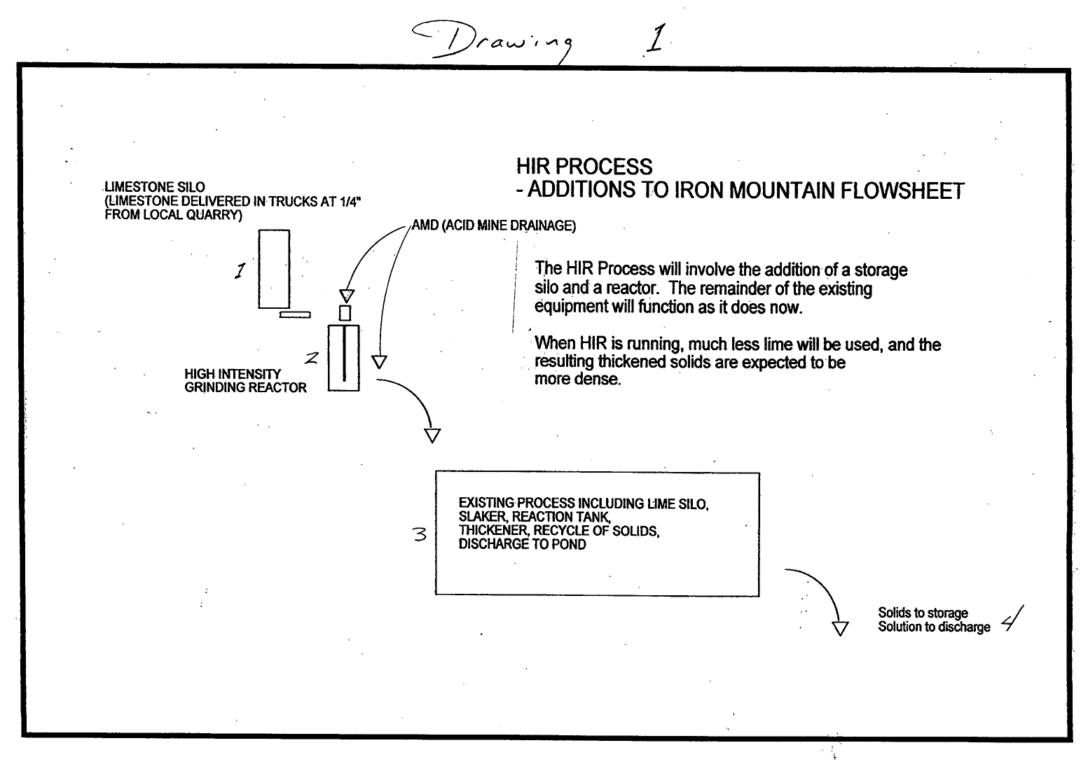

### CROSS REFERENCES RELATED TO PATENT DOCUMENTATION

This application is a Continuation-In-Part of Ser. No. 11/342,110 submitted Jan. 27, 2006. The application is also cross-referenced to the provisional patent application with title Apparatus And Methods For Neutralization Acid Rock Discharge Solutions as filed with the United States Patent and Trademark Office. The Application Number is 60/650,158 and Filing Date of the provisional patent application is Feb. 4, 2005.

### FIELD OF THE INVENTION

In the neutralization of acidic discharge solutions from mines and process plants, it is common practice to mix the solutions with hydrated or quick lime (calcium hydroxide or calcium oxide), in order to neutralize the acidic components and precipitate heavy metals and other contaminants (this process of neutralization plus precipitation is hereinafter referred to as rectification).

In most cases, limestone (calcium carbonate) should theoretically be able to neutralize the acidic components and cause the contaminants to precipitate. But in practice, limestone is not often utilized because an unreactive coating builds up on the limestone surface, thus passivating it.

### BACKGROUND OF THE INVENTION

### Rate of Reaction in Geochemical Engineering

A major concern in the design of any technological process is the rate at which it proceeds. Slow reactions require large reactors to attain a certain production. In environmental technology this can also be problematic, as public pressure demands the fast clean up of a polluted site. Geochemical processes may be very slow and this disadvantage has to be compensated. There are essentially two ways to handle this problem. The first is to speed up the reaction rate by increasing the temperature, increasing the reactant surface by grinding, increasing the strength of solutions and/or adding a catalyst. The second approach is to accept the slow reaction and reduce the costs of the environmental technology. Nature provides its own reactor and pollution is treated in situ. Space and time constraints become less severe and personnel costs are limited, as the process is a self-remediation, requiring only minimal supervision and monitoring.

Our experience with current environmental technologies shows that, while the applied technology itself may be fast, unexpected side effects may require additional costly and time-consuming measures. Only a fraction of the technologies that are effective on a laboratory scale, perform equally well under field conditions. These problems are often related to the fact that the applied process turns out to be incompatible with the inherent properties and local conditions of the treated natural system, a disadvantage that may be overcome by adhering to geochemical engineering principles.

The present invention overcomes the problems associated with long reaction time coupled with the need for increased volumes of reactive catalysts as described above in the geochemical engineering principles.

### SUMMARY OF THE INVENTION

The object of the invention is to provide a process to accelerate and make more efficient the reaction of limestone with sulfate and/or sulfuric acid solutions and/or other solutions containing sulfates. Vertical ball mills are a form of “stirred” ball mill and are routinely more energy efficient than conventional horizontal ball mills that relies on rotation of the vessel and gravitational forces from the falling rotated balls. The efficiency of a conventional ball mill for fine grinding is lower than stirred mill technologies. The stirred mill technology increase in efficiency is partially explained by placing the grinding action in solids beds that are of a more optimum thickness or porosity. The variation in the transport of the feed through the mill, the distribution of feed in the ball charge media, and the method of energy transfer to the media are also factors which help explain the difference in efficiencies.

Optimal fine grinding requires both impact and shearing force. In the mill, the rotation of the arms in a stir mill directly imparts energy to the grinding media, thus causing the balls to randomly collide with one another. These collisions create the necessary impact forces to break down individual particles in the slurry. In addition to the impact forces of the media, the balls are also spinning in different directions, thereby creating shear forces on the adjacent slurry. The combination of these impact and shearing forces results in efficient size reduction.

Although stir mill technology is presently used in fine grinding applications for mineral processing, the technology and methodology for use in the neutralization of sulfate solutions are a new and novel approach that earlier researchers and applied engineering practices did not use and the new technology is not obvious or describes in prior art or practice as a chemical reaction technology. The present invention is patentable over all other prior art.

### BRIEF DESCRIPTION OF THE DRAWINGS

One drawing is being submitted with this patent application. Drawing shows the present invention typical process flow sheet and has the following primary components: 1) Limestone Silo; 2) High Intensity Grinding Reactor; 3) Additional Process Components including, but not limited to, Lime Silo, Slaker, Reaction Tank, Thickner, Recycle of Solids, and Solution Discharge; 4) Solid to Storage and Solution to Discharge.

### DETAILED DESCRIPTION OF THE PREFERRED EMBODIMENT

An embodiment of the invention is describes the present invention as having developed a process whereby the limestone is contacted with the acidic solution in a high intensity reactor in which the limestone surfaces are continually subject to abrasion, impact, and renewal, for sufficient time to achieve efficient utilization of the limestone and to effect partial or complete rectification of the solution. The present invention relies on the breakage of the limestone in the reactor to enable a continuous and constant supply of fresh limestone surfaces that can readily react with the acid solution. This technology and methodology are a new and novel approach that earlier researchers and engineering applications did not use and is not obvious or describes in prior art or practice.

The technology in the present invention relies on both physical and chemical interrelated activities that occur simultaneously and in tandem during the high-energy grinding in the reactor. The physical breakage of the limestone is the result of mechanical actions within the reactor. The accelerated chemical reaction occurs because a freshly broken new surface becomes available when a limestone particle is broken into two particles. The availability of a fresh surface of the limestone particle allows the chemical reaction to occur. The continual breakage of the limestone particles in the reactor allows a rapid acceleration of the chemical reaction to occur, wherein the pH of the sulfate solution is raised towards a neutralized state. The breakage of a limestone particle of five millimeters in diameter to the ultimate size of five microns in diameter is a 1000 fold reduction in size. However, the availability of new-fresh surface areas for chemical reactions is significantly greater than 1000 times, because each splitting of a limestone particle affords two fresh surface areas for chemical reaction. The rate of the chemical reaction increases because the acidic sulfate solution comes into contact with the fresh surfaces of each broken limestone particle.

In one embodiment of this process, an operational plant was evaluated, in which the solution is being completely rectified using lime, from a pH of about 1.5 to a pH of 7.2. This site is a superfund site, and the owner has evaluated many alternative processes for reducing the amount of lime consumed. Limestone had been considered as an alternative or an adjunct agent, but had been rejected because it could not efficiently be used. Many companies and agencies have had the opportunity to suggest methods to improve the process as it is being commercially applied, but none of these has suggested a process similar to the present invention.

The inventors of this process applied (in a bench-scale reactor) the present invention to successfully replace all or a part of the lime, thereby effecting considerable economic savings for the owner. In this application of the process, the inventors were able to increase the pH from 1.5 to 5.0 in a high intensity reactor. This alone may be sufficient to allow discharge of the rectified solutions (the results are being evaluated in the superfund evaluation process). However, a two-stage process has been tested and is being proposed for this application, whereby the solution after limestone rectification is subject to a second stage using lime, to achieve the original superfund-defined discharge limits. The advantage of the two-stage process is that raising the pH from 1.5 to 5.0 consumes 100 to 1,000 times as much neutralizing agent (lime or limestone) as the final stage of raising the pH from 5.0 to 7.2. Limestone costs are typically less than one third of lime and by substituting limestone for the first stage of the process considerable cost savings are realized.

In the best bench-scale test (KCA32790B), 18 grams of finely crushed (10 mesh) limestone were reacted with 1000 ml of actual field solution, in a towermill with 1 mm diameter grinding balls for a total residence time of 38 minutes. The limestone was added in stages, and the evaluation of the test indicated that the residence time could have been reduced to less than 5 minutes if all the lime had been added at the start of the test. Within the tower mill, the resulting grinding ball/limestone contact reduced the final size of the reacted limestone particles to a very fine size, with a large percentage below 325 mesh (44 microns). During the test, solution pH changed from 1.7 in the feed solution, to 5.9 in the discharge solution. A total of 29 solution components (mostly dissolved metals) were analyzed for, in the feed and discharge solutions. All metal concentrations decreased significantly, with the final solution approaching acceptable discharge limits. Copper, which is a typical element with environmental control limits, decreased from 49 ppm in feed solution to 0.3 ppm in discharge solution.

In a control test, the same amount of solution was reacted with the same amount of limestone, in this case pulverized to below 100 mesh, in a stirred tank reactor. pH changed only moderately, and the decrease in heavy metal content was not significant. This test confirmed that the “common knowledge” method of applying limestone neutralization, which does not recognize the importance of the high intensity surface interaction between the limestone and the reactor surfaces, is not practical.

What is claimed is:

1-74. (canceled)

75. The process of reacting an acidic or high-dissolved-solids solution with limestone whereby the reaction takes place in a high intensity reactor which continually renews and impacts the surfaces of the limestone, in order to affect a rapid reaction rate and an efficient utilization of the limestone.

76. The process of claim 75 wherein the high intensity reactor is a grinding mill in which the limestone is continually contacted with the grinding mill parts.

77. The process of claim 75 wherein the high intensity reactor is a high intensity vibrating mill in which the limestone is continually contacted with the grinding mill parts.

78. The process of claim 75 wherein the high intensity reactor is a high intensity stir mill in which the limestone is continually contacted with the grinding mill parts.

79. The process of claim 75 wherein not all of the ground limestone is reacted with the solution and the ground limestone is introduced into the process stream outside the high intensity reactor where additional neutralization occurs.

80. The process of claim 75 whereby the acidic solution is a discharge solution from a mine or chemical process plant and the purpose of neutralization is to achieve or approach acceptable process limits.

81. The process of claim 75, in which the limestone is continually contacted with the reactor parts whereby the acidic solution is a discharge solution from a chemical process plant and the purpose of neutralization is to achieve or approach acceptable process limits, in which the solution is a dilute, slightly acidic sulfate solution of the type commonly encountered in process streams from mines and chemical processing plants.

82. The process of claim 75, in which the limestone slurry, after discharge from the reactor, is partially thickened, and a dense slurry stream is recycled to the reactors, with the purposes of completing the utilization of the reagents, and of nucleating the resulting product so that it filters and settles more rapidly than a non-nucleated product.

83. The process of claim 75, in which the limestone slurry, after discharge from the reactor, is partially thickened, and a dense slurry stream is recycled to the reactor, with the purpose of completing the utilization of the reagents, and of nucleating the resulting product so that it filters and settles more rapidly than a non-nucleated product, followed by discharging the liquids in an environmentally acceptable manner and disposing of the solids in an acceptable solids disposal facility.

84. The process of claim 75, in which the limestone slurry is partially thickened, and a dense slurry stream is recycled to the reactors, with the purpose of completing the utilization of the reagents, and of nucleating the resulting product so that it filters and settles more rapidly than a non-nucleated product for achieving solution rectification that is enhanced by aeration or oxidation within the reactor as the acid neutralization process is ongoing.

85. The process of claim 75, in which the limestone slurry is partially thickened, and a dense slurry stream is recycled to the reactors, with the purposes of completing the utilization of the reagents, and of nucleating the resulting product so that it filters and settles more rapidly than a non-nucleated product, as it is applied in conjunction with other processes, or as part of a larger processing system.

87. The process of claim 75, in which the limestone slurry is partially thickened, and a dense slurry stream is recycled to the reactor, with the purpose of completing the utilization of the reagents, and of nucleating the resulting product so that it filters and settles more rapidly than a non-nucleated product, as they it is applied in conjunction with the addition of other chemicals to enhance the reaction.

87. The two stage process of reacting an acidic solution with limestone in a high intensity reactor in order to affect a rapid reaction rate, an efficient utilization of limestone, and a partial rectification of the solution, followed by a second stage whereby the solution and the limestone slurry is contacted with hydrated or quick lime to complete the rectification of the solution.

88. The process of claim 87, wherein the high intensity reactor is a grinding mill in which the limestone is continually contacted with the grinding mill parts.

89. The process of claim 87, wherein the high intensity reactor is a high intensity vibrating mill, in which the limestone is continually contacted with the grinding mill parts.

90. The process of claim 87 wherein the high intensity reactor is a high intensity stir mill in which the limestone is continually contacted with the grinding mill parts.

91. The process of claim 87 wherein not all of the ground limestone is reacted with the solution and the ground limestone is introduced into the process stream outside the high intensity reactor where additional neutralization occurs.

92. The process of claim 87, whereby the acidic solution is a discharge solution from a chemical process plant and the purpose of neutralization is to achieve or approach acceptable process limits.

93. The process of claim 87, in which the limestone slurry is partially thickened, and a dense slurry stream is recycled to the reactors, with the purposes of completing the utilization of the reagents, and of nucleating the resulting product so that it filters and settles more rapidly than a non-nucleated product.

94. The process of claim 87, in which the limestone slurry is partially thickened, and a dense slurry stream is recycled to the reactors, with the purposes of completing the utilization of the reagents, and of nucleating the resulting product so that it filters and settles more rapidly than a non-nucleated product followed by filtering or settling the slurry to remove the solids from the liquids, followed by discharging the liquids in an environmentally acceptable manner and disposing of the solids in an acceptable solids disposal facility.

95. The process of claim 87, in which the limestone slurry is partially thickened, and a dense slurry stream is recycled to the reactors, with the purposes of completing the utilization of the reagents, and of nucleating the resulting product so that it filters and/or settles more rapidly than a non-nucleated product for achieving solution rectification, that is enhanced by aeration and oxidation within the reactor as the acid neutralization process is ongoing.

96. The process of claim 87, in which the limestoneslurry is partially thickened, and a dense slurry stream is recycled to the reactors, with the purposes of completing the utilization of the reagents, and of nucleating the resulting product so that it filters and/or settles more rapidly than a non-nucleated product, as it is applied in conjunction with other processes.

97. The process of claim 87, in which the limestone slurry is partially thickened, and a dense slurry stream is recycled to the reactors, with the purposes of completing the utilization of the reagents, and of nucleating the resulting product so that it filters and/or settles more rapidly than a non-nucleated product, as it is applied in conjunction with the addition of other chemicals to enhance the reaction.
